(19) United States
(12) Patent Application Publication
(10) Pub. No.: US 2006/0151647 A1
(43) Pub. Date: Jul. 13, 2006

(54) Compacting device

(75) Inventors: Michael John Easton, Hampshire (GB); Michael David Sawford, Buckinghamshire (GB)

Correspondence Address: MICHAEL BEST & FRIEDRICH, LLP, 100 E WISCONSIN AVENUE, MILWAUKEE, WI, 53202, US

(73) Assignee: ACCO UK Limited, Buckinghamshire (GB)

(21) Appl. No.: 11/297,804

(22) Filed: Dec. 8, 2005

(30) Foreign Application Priority Data
Dec. 10, 2004 (GB) 0427091.4

(51) Int. Cl. B02C 19/00

(52) U.S. Cl. 241/101.2

(57) ABSTRACT

A compacting device, adapted for use with a receptacle for the collection of shredded material output from a shredder, the compacting device comprising a plate provided with an aperture, fixed relative to the receptacle, such that shredded material output from the shredder passes through the aperture of the plate and is collected in the receptacle and as collection of the shredded material within the receptacle progresses the compacting device acts to compact the material. The compacting device may act to compact the shredded material by compression of the material between bottom and sides of the receptacle and the plate as collection of the material progresses. As the receptacle starts to fill up with shredded material, the material pushes against the plate, and as the plate is fixed relative to the receptacle, this acts to compact the material. The compaction device may act to compact the shredded material by action of the aperture to form and maintain a substantially pyramidal mass of material beneath the aperture, against which further material output from the shredder is compressed. The compaction device may act to hold at least a substantial part of the shredded material within the receptacle until it is desired to empty the receptacle. In this way, when the receptacle is removed from the shredder prior to emptying, the compacted material does not spring out of the receptacle, but is held within it by the plate. Using the compacting device, the receptacle requires to be emptied less often and is also easier to empty.

### BACKGROUND

The invention relates to a compacting device, particularly for use in compacting paper which has been shredded.

Conventionally, shredders, such as, bin-top or cabinet paper shredders are each used in conjunction with a bin to collect the paper once it has been shredded. During the process of shredding and then collecting, the shredded paper is compacted within the bin to, generally, only a limited extent. The bin can therefore quickly become substantially full of mostly non-compacted paper. In bin-top shredders, further collection of shredded paper in the bin will tend to lift the head of the shredder off the bin. In cabinet shredders, further collection of shredded paper in the bin tends to cause activation of a ‘bin full’ indicator or the bin to ‘pop out’ away from the shredder. In either case, shredding is usually ceased and the bin emptied. If the shredded paper where to be further compacted, the bin could be emptied less often. Further compaction is often achieved by compression of the paper by hand, but this requires manual intervention, which can be undesirable.

### SUMMARY

According to a first aspect of the invention there is provided a compacting device, adapted for use with a receptacle for the collection of shredded material output from a shredder,

the compacting device comprising

a plate provided with an aperture, fixed relative to the receptacle,

such that shredded material output from the shredder passes through the aperture of the plate and is collected in the receptacle and

as collection of the shredded material within the receptacle progresses the compacting device acts to compact the material.

The compacting device may act to compact the shredded material by compression of the material between bottom and sides of the receptacle and the plate as collection of the material progresses. As the receptacle starts to fill up with shredded material, the material pushes against the plate, and as the plate is fixed relative to the receptacle, this acts to compact the material.

The compaction device may act to compact the shredded material by action of the aperture to form and maintain a substantially pyramidal mass of material beneath the aperture, against which further material output from the shredder is compressed.

Conventionally, shredders may output shredded material in a substantially pyramidal mass. Using a compacting device with an aperture, acts to enhance formation and maintenance of such a mass of material, and therefore enhances compaction of the material.

The compaction device may act to hold at least a substantial part of the shredded material within the receptacle until it is desired to empty the receptacle. In this way, when the receptacle is removed from the shredder prior to emptying, the compacted material does not spring out of the receptacle, but is held within it by the plate.

It can be seen that using a compaction device allows a user to continue shredding for longer than is the case with a conventional shredder and receptacle. Using the compacting device, the receptacle requires to be emptied less often and is also easier to empty.

The compacting device may be fixed onto an open end of the receptacle. The compacting device may be fixed within the receptacle, at a depth beneath an open end thereof. The shredder may then be at least partially placed within the receptacle, above the compacting device. The plate of the compacting device may have a size which is comparable to the cross sectional area of the open end of the receptacle.

A first side of the compacting device may be hingeably fixed to a first side of the receptacle. A second side of the compacting device may be releasably fixed to a second side of the receptacle. A first side and a second side of the compacting device may be fixed to first and second sides of the receptacle.

The plate of the compacting device may have a size which is comparable to the cross sectional area of a shredding head of the shredder. The compacting device may have a profile which at least substantially matches a profile of the shredding head of the shredder.

The compacting device may be positioned relative to the shredder such that the distance between the shredder and the compacting device is as small as possible. The compacting device may be positioned relative to the shredder such that the aperture of the device is substantially aligned with an outlet aperture of the shredder. The aperture of the compacting device may have a size of for example 220 to 250 mm by 50 to 60 mm, more particularly 225 mm by 50 mm.

The plate of the compacting device may comprise a sloped portion between two substantially parallel portions, and the aperture may be provided in the sloped portion. This is particularly useful when the device is used with a receptacle which is removed from a shredder to be emptied by pulling it along the length of the shredder. Shredded material is less likely to impede removal the receptacle.

The receptacle may be provided with a moveable bottom which is biased towards the compacting plate. As shredded material is collected in the receptacle, the moveable bottom may move away from the compacting device, gradually increasing the volume of the receptacle in which material may be collected. This may act with the compacting device to provided further compaction of the shredded material. This is particularly useful when a relatively large receptacle is being used.

The compacting device may be used with bin-mounted shredders and with cabinet-type shredders. The compacting device may be used with strip cut shredders and confetti cut shredders. The shredded material may comprise shredded paper.

According to a second aspect of the invention there is provided a compacting device according to the first aspect of the invention in combination with a receptacle.

### BRIEF DESCRIPTION OF THE DRAWINGS

An embodiment of the invention will now be described by way of example only, with reference to the accompanying drawings, in which:

FIG. 1 is a perspective schematic representation of a compacting device, according to the invention;

FIG. 2 is perspective schematic representation of the compacting device of FIG. 1 fixed within an open end of a receptacle, and

FIG. 3 is cross sectional schematic representation of the compacting device and receptacle of FIG. 2 with a shredder.

### DETAILED DESCRIPTION

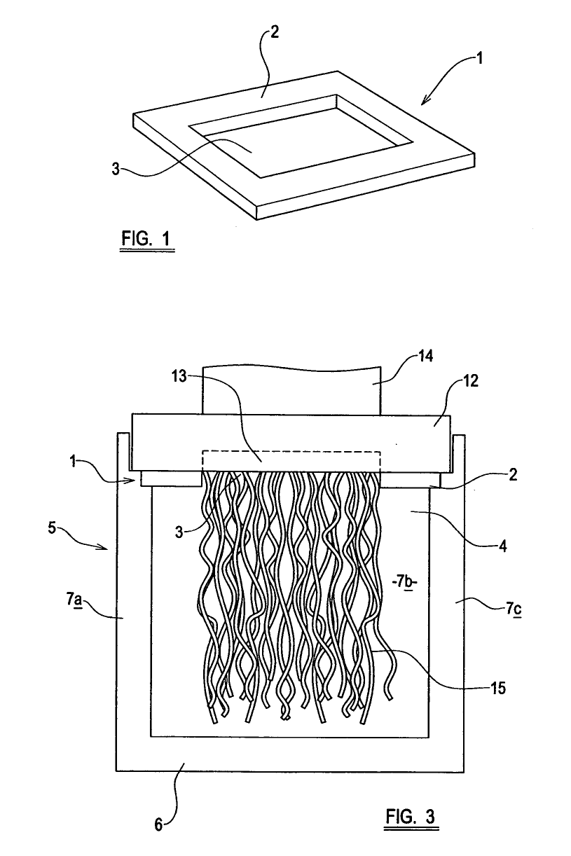

FIG. 1 shows a first embodiment of a compacting device 1, which comprises a plate 2 which is substantially rectangular in shape. The plate is provided with an aperture 3, which is positioned approximately centrally in the plate, and is also substantially rectangular in shape. The aperture 3 has a size of approximately 225 mm by 50 mm.

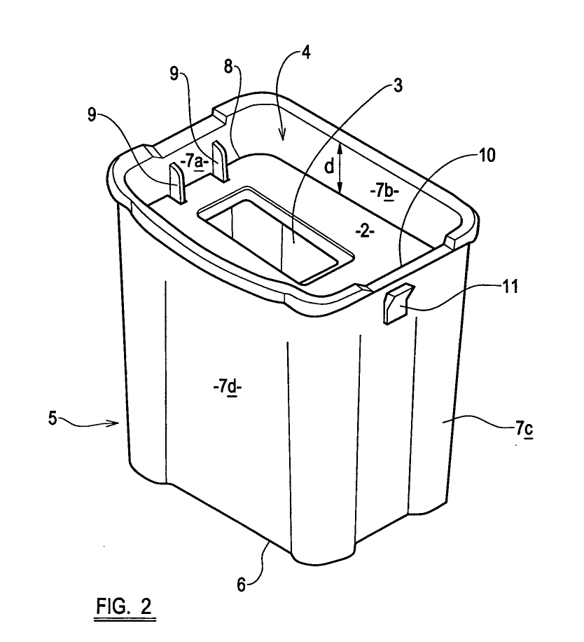

FIG. 2 shows the compacting plate 1 of FIG. 1, fixed in an open end 4 of a receptacle which comprises a bin 5, at a depth d beneath the open end. The bin comprises a bottom 6 and four sides 7a, 7b, 7c and 7d. A first end 8 of the plate 2 of the compacting device is fixed to a first side 7a of the bin 5, by hinges 9. The hinges may comprise living hinges. A second, opposite end 10 of the plate 2 of the compacting device is held by a catch 11 against a second side 7c of the bin 5. The catch is releasable, and the plate 2 pivots between a closed position as shown in the figure, and an open position in which the bin may be emptied. The plate 2 of the compacting device has a size which is comparable to the cross sectional area of the open end of the bin 5, i.e. the plate 2 substantially fills and closes off the open end 4 of the bin 5.

FIG. 3 shows the compacting device 1 and bin 5 of FIG. 2, in use with a shredder 12. The shredder is positioned on the open end 4 of the bin 5, and partially extends within the bin as shown. The shredder 12 is not fixed to the bin 5, but rests on the open end of the bin. The compacting device 1 is positioned relative to the shredder 12 such that the distance between them is as small as possible. The compacting device 1 is also positioned relative to the shredder 12 such that the aperture 3 of the device is substantially aligned with an outlet aperture 13 of the shredder 12.

The shredder 12 receives paper 14, and shreds this into shredded material which comprises strips of paper. These are output from the outlet aperture 13 of the shredder 12, and are passed through the aperture 3 of the plate 2 of the compacting device 1, and are collected in the bin 5. The shredded paper forms an approximately pyramidal mass of material 15 beneath the aperture 3. As the bin 5, starts to fill with shredded paper, eventually this starts to press against the underside of the plate 2. As the plate 2 is fixed relative to the bin 5, the shredded paper is compacted by compression thereof between the bottom and sides of the bin 5 and the plate 2 as collection of the shredded paper progresses. In addition, as more and more paper is shredded, this is compressed against a top portion of the pyramidal mass of shredded paper 15 which is formed beneath the aperture 3, and thus the shredded paper is also compacted. Thus more shredded paper may be collected in the bin 5, than may be collected in a comparable bin from a comparable shredder without use of the compacting plate.

When it is desired to empty the bin 5, the shredder 12 is lifted away from the open end of the bin. The plate 2 of the compaction device 1 will remain in the closed position, and will act to hold at least a substantial part of the shredded paper within it. The bin 5 can then be placed in a refuse sack, and the catch 11 released, allowing the plate 2 to pivot to an open position, and the shredded paper to be released into the sack.

It will be appreciated that both sides 8 and 10 of the plate 2 can be rigidly fixed to the sides 7a and 7c of the bin 5. The bin 5 may then be emptied through one of the sides or through the bottom thereof.

The above describes use of the compacting device with a bin-mounted shredder. However, it will be appreciated that this compacting device can also be used in a bin which is positioned below a cabinet-type shredder.

An alternative embodiment of the compacting device of the invention comprises a plate having first and second substantially parallel portions which are separated by a sloped portion. An aperture is provided in the sloped portion. This compacting device is utilised in the same way as that described above, and has approximately the same compacting action as the device described above. This type of compacting device is particularly useful when the device is used with a receptacle which is removed from a shredder to be emptied by pulling it along the length of the shredder. Shredded material is less likely to impede removal of the receptacle.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. A compacting device, adapted for use with a receptacle for the collection of shredded material output from a shredder,
the compacting device comprising
a plate provided with an aperture, fixed relative to the receptacle,
such that shredded material output from the shredder passes through the aperture of the plate and is collected in the receptacle and
as collection of the shredded material within the receptacle progresses the compacting device acts to compact the material.

2. A compacting device according to claim 1 which acts to compact the shredded material by compression of the material between bottom and sides of the receptacle and the plate as collection of the material progresses.

3. A compaction device according to claim 1 which acts to compact the shredded material by action of the aperture to form and maintain a substantially pyramidal mass of material beneath the aperture, against which further material output from the shredder is compressed.

4. A compaction device according to claim 1 which acts to hold at least a substantial part of the shredded material within the receptacle until it is desired to empty the receptacle.

5. A compacting device according to claim 1 which is fixed onto an open end of the receptacle.

6. A compacting device according to claim 1 which is fixed within the receptacle, at a depth beneath an open end thereof.

7. A compacting device according to claim 1 in which the plate of the compacting device has a size which is comparable to the cross sectional area of the open end of the receptacle.

8. A compacting device according to claim 1 in which a first side of the compacting device is hingeably fixed to a first side of the receptacle, and a second side of the compacting device is releasably fixed to a second side of the receptacle.

9. A compacting device according to claim 1 in which a first side and a second side of the compacting device are rigidly fixed to first and second sides of the receptacle.

10. A compacting device according to claim 1 in which the plate of the compacting device has a size which is comparable to the cross sectional area of a shredding head of the shredder.

11. A compacting device according to claim 1 which has a profile which at least substantially matches a profile of the shredding head of the shredder.

12. A compacting device according to claim 1 which is positioned relative to the shredder such that the distance between the shredder and the compacting device is as small as possible.

13. A compacting device according to claim 1 in which is positioned relative to the shredder such that the aperture of the device is substantially aligned with an outlet aperture of the shredder.

14. A compacting device according to claim 1 in which the plate of the compacting device comprises a sloped portion between two substantially parallel portions, and the aperture may be provided in the sloped portion.

15. A compacting device according to any of claims 1 to 14 in combination with a receptacle.
